(19) United States
(12) Patent Application Publication
(10) Pub. No.: US 2012/0234776 A1
(43) Pub. Date: Sep. 20, 2012

(54) Treatment of Water

(75) Inventor: Theodore Taylor Sand, Poway, CA (US)

(73) Assignee: EMPIRE TECHNOLOGY DEVELOPMENT LLC, Wilmington, DE (US)

(21) Appl. No.: 13/147,557

(22) PCT Filed: Mar. 18, 2011
(86) PCT No.: PCT/US2011/028984

§ 371 Date: Aug. 2, 2011

(51) Int. Cl. B01D 43/00; B01D 36/00; B01D 24/38; C02F 1/00; B01D 21/30

(52) U.S. Cl. 210/804; 210/138; 210/195.1

(57) ABSTRACT

Examples are disclosed for treating water received from one or more sources or treating water that has been stored in a storage container.

### BACKGROUND

Unless otherwise indicated herein, the approaches described in this section are not prior art to the claims in this application and are not admitted to be prior art by inclusion in this section.

Growing worldwide demand for potable water has intensified efforts to recycle/reuse or treat water of various qualities. In some examples, a certain type of reused water may be referred to as “grey water”. Grey water may be water that originated from industrial, commercial or residential sources to include, but not limited to, shower wastewater, bath wastewater, bathroom sink wastewater, kitchen sink wastewater or laundry wastewater. Grey water may be used in a variety of applications to include water for landscaping, growing crops, industrial applications to include concrete production and supplementing water used for toilet flushing. A possibly major limitation on using grey water is the short time limit for storage of grey water. For example, in some areas of the United States of America (e.g., the State of Oregon) regulations associated with the use of grey water dictate that grey water can be stored no more than 24 hours before being used for at least some of the above-mentioned applications. A 24-hour storage limit may unacceptably limit the volume available for the use of grey water.

### SUMMARY

The present disclosure describes example methods for treating water. Example methods may include receiving the water from one or more sources. The water may have particles associated with bacteria and/or organic matter and may be filtered through a large particle filtration module. Also, the particles associated with bacteria and/or organic matter may be separated from at least a portion of the water at a separation area that may be downstream of the large particle filtration module. The inertial flow device may further include a flow channel to laterally focus the particles. The separated particles may then be discharged from the flow channel and the remaining water in the flow channel may be transported to a storage container.

The present disclosure also describes example inertial flow devices for treating water. The example inertial flow devices may include an inlet configured to receive water that has been filtered through a large particle filtration module and a mid-section fluidly coupled to the inlet. The mid-section may be configured to laterally focus particles associated with bacteria and/or organic matter suspended in the water. The example inertial flow devices may also include a separation area along the flow channel that may be configured to separate the laterally focused particles from at least a portion of the water. The example inertial flow devices may also include a discharge area downstream from the separation area that may be configured to discharge the separated particles from the flow channel. The example inertial flow devices may also include an outlet downstream from the discharge area. In some examples, the outlet may be configured to transport the remaining water in the flow channel to a storage container.

The present disclosure also describes example systems for treating water. The example systems may include a large particle filtration module configured to filter water received from one or more sources. The example systems may also include an inertial flow device having a flow channel that has an inlet configured to receive water that has been filtered through the large particle filtration module. The flow channel may also have a mid-section that may be fluidly coupled to the inlet. In some examples, the mid-section may be configured to laterally focus particles associated with bacteria and/or organic matter suspended in the water. The flow channel may further include a separation area that may be configured to separate the laterally focused particles from at least a portion of the water and a discharge area downstream from the separation area that may be configured to discharge the separated particles from the flow channel. The flow channel may also have an outlet downstream from the discharge area. In some examples, the outlet may be configured to move the remaining water in the flow channel to the storage container.

The present disclosure also describes example computer program products. In some examples, the computer program products may include a signal-bearing medium having instructions for treating water that has been stored in storage container via use of an inertial flow device fluidly coupled to the storage container. The instructions, which, when executed by logic may cause the logic to determine whether a period of time has been exceeded. The instructions may also cause the logic to activate a pump configured to move the water from the storage container to the inertial flow device based at least in part on whether the period of time has been exceeded. In some examples, the inertial flow device may treat the water. The inertial flow device may include a flow channel having an inlet to receive the water and a mid-section fluidly coupled to the inlet. The mid-section may be configured to laterally focus particles associated with bacteria and/or organic matter suspended in the water. The inertial flow device may also include a separation area that may be configured to separate the laterally focused particles from at least a portion of the water. The inertial flow device may also include a discharge area downstream from the separation area that may be configured to discharge the separated particles from the flow channel. The inertial flow device may also include an outlet downstream from the discharge area that may be configured to move the remaining water in the flow channel back to the storage container.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a block diagram of an example system for treating water from one or more sources;

FIG. 2 illustrates a graphical representation of an example flow channel for an inertial flow device;

FIGS. 3A-C illustrate graphical representations of example shapes for a mid-section of an inertial flow device;

FIG. 4 illustrates a block diagram of an example architecture for a treatment control module;

FIG. 5 illustrates a flow chart of example methods for treating water;

FIG. 6 illustrates a block diagram of an example computer program product; and

FIG. 7 illustrates an example computing device; all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples or embodiments described in the detailed description, drawings, and claims are not meant to be limiting. Other examples or embodiments may be utilized, and other changes may be made, without departing from the spirit or scope of the subject matter presented here. It will be readily understood that aspects of this disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer program products for treating water received from one or more sources or treating water that has been stored in a storage container.

As contemplated in the present disclosure, relatively short time limits on storage of grey water may be a major limitation on the use of grey water. Further, in order to extend the amount of time reused water may be stored, the grey water may be treated to remove microbial bioburden such as bacteria or other types of organic matter. In some examples, the microbial bioburden, if left untreated, may rapidly convert the grey water to a lower quality of water commonly referred to as “black water.” Black water, for example, may be similar to water that may be discharged to a sewer system. Finding inexpensive treatment techniques for grey water may be difficult. Further, finding inexpensive treatment techniques suitable for the use of grey water in a residential setting may be even more difficult.

In some examples, methods are implemented for treating water. Example methods may include receiving the water from one or more sources (e.g., residential sources). The water may have particles associated with bacteria and/or organic matter and may be filtered through a large particle filtration module. Also, the particles associated with bacteria and/or organic matter may be separated from at least a portion of the water at a separation area that may be downstream of the large particle filtration module. The inertial flow device may further include a flow channel to laterally focus the particles. The separated particles may then be discharged from the flow channel and the remaining water in the flow channel may be transported to a storage container.

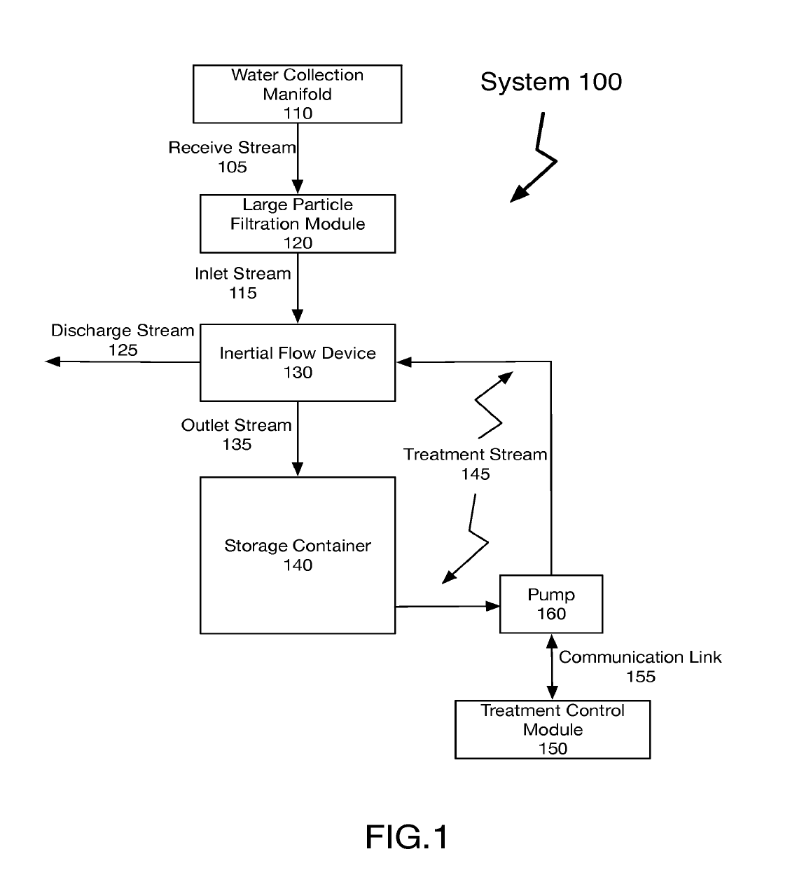

FIG. 1 illustrates a block diagram of an example system 100 for treating water from one or more sources, arranged in accordance with at least some embodiments of the present disclosure. As shown in FIG. 1, system 100 includes a water collection manifold 110, a large particle filtration module 120, an inertial flow device 130, a storage container 140 and a pump 160. Also, water collection manifold 110 and large particle filtration module 120 may be fluidly coupled via a receive stream 105, large particle filtration module 120 and inertial flow device 130 may be fluidly coupled via an inlet stream 115, and inertial flow device 130 and storage container 140 may be fluidly coupled via an outlet stream 135. Further, as shown in FIG. 1, a treatment control module 150 may be communicatively coupled to pump 160 via a communication link 155. Pump 160, responsive to treatment control module 150, may be utilized to facilitate fluidly coupling storage container 140 to inertial flow device 130 via a retreatment stream 145. FIG. 1 also shows a discharge stream 125 coupled to inertial flow device 130. In some examples, discharge stream 125 may fluidly couple inertial flow device 130 to a sewer system (not shown). Although not shown in FIG. 1, receive stream 105, inlet stream 115, discharge stream 125, outlet stream 135 and retreatment stream 145 may be moved or transported to the various elements depicted in FIG. 1 using various types of piping or other water transport means.

In some examples, water collection manifold 110 may collect water or grey water from one or more residential sources. Although not shown, water collection manifold 110 may be a compilation of various pipes, conduits or other water transport means to collect grey water from sources to include shower wastewater, bath wastewater, bathroom sink wastewater, kitchen sink wastewater or laundry wastewater and then send the collected grey water towards large particle filtration module 120 via receive stream 105.

In some examples, large particle filtration module 120 may receive the grey water via receive stream 105. Large particle filtration module 120 may be configured to include filters and/or traps to remove large particles and/or grease from the received grey water. For example, the filters (not shown) may be similar to a typical sediment filter used to filter household water sources and may remove particles having a nominal diameter of greater than 1 millimeter (mm). The traps (not shown) may remove some or most of the grease and may be similar to the types of grease traps or grease interceptors used in restaurants or grocery stores. However, this disclosure contemplates other nominal diameters for the removal of relatively large particles that may be of a higher or lower nominal diameter to facilitate efficient operation of system 100 (e.g., low maintenance and/or relatively clog-free operation).

In some examples, the grey water that has been filtered through large particle filtration module 120 may still include substantial amounts of suspended particles associated with bacteria and/or organic matter. As described in more detail below, inertial flow device 130 may include a flow channel to separate at least some of the particles associated with bacterial and/or organic matter from grey water received via inlet stream 115. The separated particles may then be discharged from inertial flow device 130 via discharge stream 125. The remaining grey water may then be transported to storage container 140 via outlet stream 135.

In some examples, grey water in storage container 140 may need to be retreated to prevent the build-up of additional particles associated with bacteria and/or organic matter. The additional particles may have resulted from relatively small amounts of bacterial and/or organic matter that may have not been separated from the grey water by inertial flow device 130. Treatment control module 150 may include logic configured to periodically activate pump 160 to move grey water from storage container 140 to inertial flow device 130 via retreatment stream 145 to separate at least some of the additional particles from the grey water in storage container 140. Treatment control module 150, for example, may periodically activate pump 160 based, at least in part, on a period of time being reached and/or exceeded. The period of time may include a predetermined amount of time such as 24 hours or other amounts of predetermined time.

Although not shown in FIG. 1, system 100 may include a second inertial flow device similar to inertial flow device 130 to retreat grey water from storage container 140. For these examples, retreatment stream 145 may fluidly couple the second inertial flow device to storage container 140 instead of fluidly coupling with inertial flow device 130 as shown in FIG. 1. In some examples, the second inertial flow device may be configured such that possibly smaller sized additional particles associated with bacteria and/or organic matter may be separated from the grey water received from storage container 140.

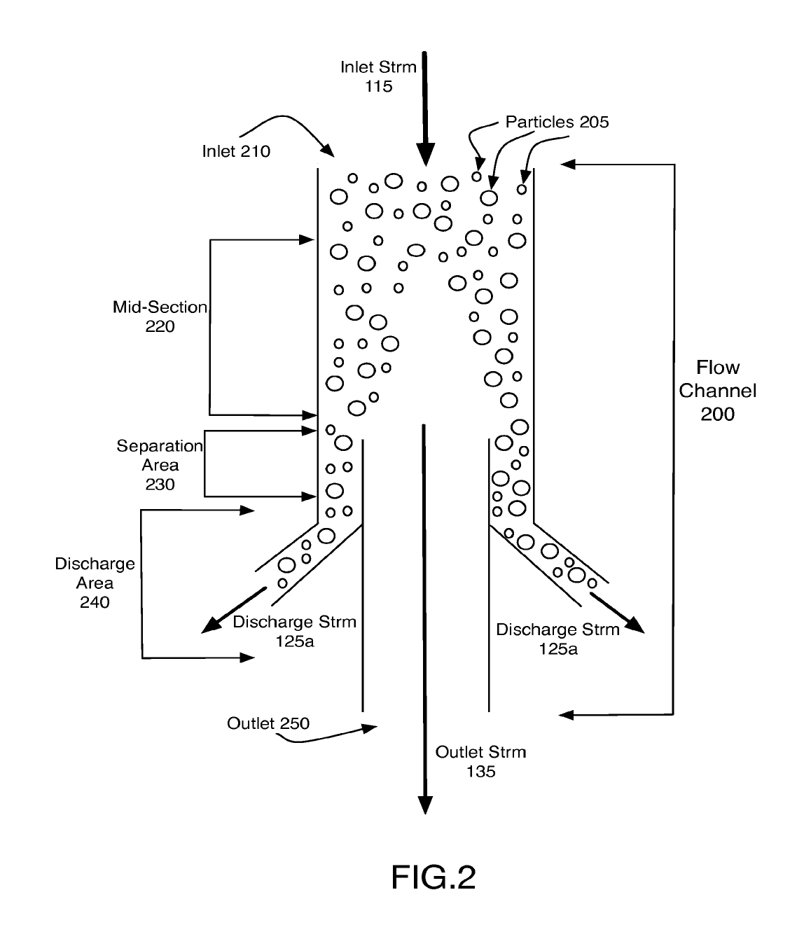

FIG. 2 illustrates a graphical representation of an example flow channel 200 for inertial flow device 130, arranged in accordance with at least some embodiments of the present disclosure. As mentioned above, inertial flow device 130 may receive grey water via inlet stream 115. In some examples, flow channel 200, as shown in FIG. 2, may include an inlet 210, a mid-section 220, a separation area 230, a discharge area 240 and an outlet 250. Also shown in FIG. 2 are particles 205. Particles 205 may include particles associated with bacteria and/or organic matter that may be suspended in grey water received via inlet stream 115.

In some examples, inlet 210 may be configured to receive grey water that has been filtered through large particle filtration module 120 as mentioned above for FIG. 1. Mid-section 220 may be fluidly coupled to inlet 210 and may be configured to laterally focus particles 205 suspended in the grey water. In some examples, laterally focusing particles 205 may include mid-section 220 being configured or shaped in a manner such that inertial hydrodynamic forces (e.g., inertial lift) and/or drag forces (e.g., Dean forces) cause particles 205 to be laterally focused as the grey water moves through flow channel 200. Although FIG. 2 depicts particles 205 being laterally focused to the outer portion of flow channel 200, as described in further detail below, mid-section 220 may also be configured or shaped to laterally focus particles 205 to an inner portion of flow channel 200.

Separation area 240, in some examples, may be an area of flow channel 200 where particles 200 have become sufficiently laterally focused to enable particles 205 to be separated from the grey water as the grey water moves through flow channel 200. As shown in FIG. 2, at separation area 230, particles 205 may be diverted away from flow channel 200. Diverted particles 205 may then be discharged from flow channel 200 at discharge area 240. As depicted in FIG. 2, discharge area 240 may be located downstream of separation area 230 and may discharge particles 205 from flow channel 200 via either discharge stream 125a or 125b. Also, outlet 250 may be located downstream of discharge area 240 and may be configured to move or transport the grey water remaining in flow channel 200 to a storage container (e.g., storage container 140) via outlet stream 135.

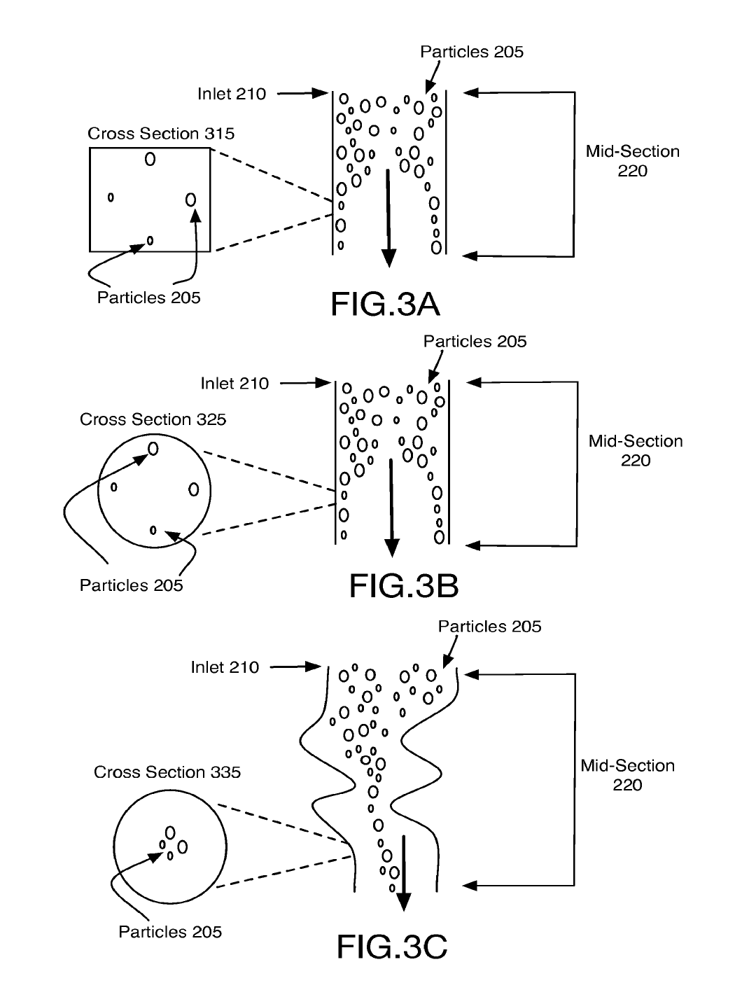

FIGS. 3A-C illustrate graphical representations of example shapes of a section of flow channel 200 for inertial flow device 130, arranged in accordance with at least some embodiments of the present disclosure. In some examples, the section of flow channel 200 may include mid-section 220. Also, particles 205, as mentioned above, may include particles associated with bacteria and/or organic matter suspended in grey water received via inlet 210 of inertial flow device 130. FIG. 3A, for example, shows an enlarged cross-section 315 that depicts mid-section 220 as being substantially square-shaped. Both enlarged cross-section 315 and the full view of mid-section 220 of FIG. 3A depict particles 205 becoming laterally focused to an outer portion of flow channel 200. FIG. 3B, for example, shows an enlarged cross-section 325 that depicts mid-section 220 as being substantially circular-shaped. Similar to FIG. 3A, both enlarged cross-section 325 and the full view of mid-section 220 of FIG. 3A depict particles 205 becoming laterally focused to an outer portion of flow channel 200.

FIG. 3C, for example, shows an enlarged cross-section 335 that depicts mid-section 220 as being substantially circular-shaped. Also, the full view of mid-section 220 in FIG. 3C depicts an asymmetric curve-shaped channel for channel 200 compared to relatively straight channels depicted in FIGS. 3A and 3B. In some examples, inertial hydrodynamic forces and/or drag forces resulting from the asymmetric curve-shaped channel may cause particles 205 to become laterally focused in an inner portion of flow channel 200 rather than an outer portion as depicted in FIGS. 3A and 3B. Thus, as shown in both enlarged cross-section 335 and the full view of mid-section 220 of FIG. 3C, particles 205 may become laterally focused to an inner portion of flow channel 200 as grey water moves down channel 200.

In some examples, as shown in FIGS. 3A-3C, laterally focused particles 205 at the outer portion or inner portion of flow channel 200 may result in grey water becoming substantially free of particles 205 as the grey water moves downstream within flow channel 200. Dimensional factors such as the width/diameter and length of flow channel 200 at mid-section 220 as well as the flow rate of the grey water through flow channel 200 may determine how far the grey water may need to travel before particles 205 have become laterally focused enough to separate an acceptable amount of particles 205 from the grey water. For example, for a flow channel having a diameter of 1.2 centimeters (cm) a length of 20 cm and a flow rate of approximately 1.8 meters/second, an acceptable amount of particles 205 that are less than 1 mm in diameter may be separated from the grey water. Acceptable amounts of particles 205 may include, but are not limited to, separation of enough bacteria and/or organic matter to extend storage times for grey water beyond 24 hours. Other dimensional factors such as the number of asymmetric curves for a curve-shaped channel may also be considered when designing a flow channel 200 at mid-section 220 that may laterally focus particles 205 at an inner portion of flow channel 200.

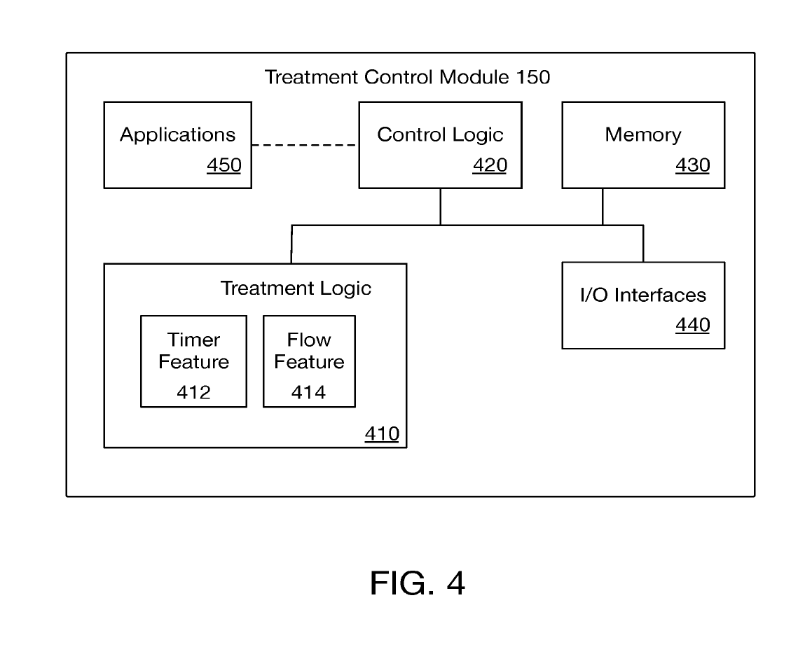

FIG. 4 illustrates a block diagram of an example architecture for treatment control module 150, arranged in accordance with at least some embodiments of the present disclosure. The example treatment control module 150 of FIG. 4 includes treatment logic 410, control logic 420, a memory 430, input/output (I/O) interfaces 440 and optionally one or more applications 450. As illustrated in FIG. 4, treatment logic 410 is coupled to control logic 420, memory 430 and I/O interfaces 440. Also illustrated in FIG. 4, the optional applications 450 are arranged in cooperation with control logic 420. Treatment logic 410 may further include one or more of a timer feature 412 or a flow feature 414 or any reasonable combination thereof.

In some examples, the elements portrayed in FIG. 4's block diagram are configured to support or enable treatment control module 150 as described in this disclosure. A given treatment control module 150 may include some, all or more elements than those depicted in FIG. 2. For example, treatment logic 410 and control logic 420 may separately or collectively represent a wide variety of logic device(s) to implement the features of treatment control module 150. An example logic device may include one or more of a computer, a microprocessor, a microcontroller, a field programmable gate array (FPGA), an application specific integrated circuit (ASIC), a sequestered thread or a core of a multi-core/multi-threaded microprocessor or a combination thereof.

In some examples, as shown in FIG. 4, treatment logic 410 includes one or more of a timer feature 412 or a flow feature 414. Treatment logic 410 may be configured to use one or more of these features to perform operations. As described in more detail below, example operations may include activating or cause a pump (e.g., pump 160) to be activated to move water (e.g., grey water) from a storage container (e.g., storage container 140) to an inertial flow device (e.g., inertial flow device 130) based, at least in part, on whether a time period has been exceeded.

In some examples, control logic 420 may be configured to control the overall operation of treatment control module 150. As mentioned above, control logic 420 may represent any of a wide variety of logic device(s) configured to operate in conjunction with executable content or instructions to implement the control of treatment control module 150. In some alternate examples, the features and functionality of control logic 420 may be implemented within treatment logic 410.

According to some examples, memory 430 is arranged to store executable content or instructions. The executable content or instructions may be used by control logic 420 and/or treatment logic 410 to implement or activate features or elements of treatment control module 150. Memory 430 may also be arranged to temporarily maintain criteria (e.g., predetermined time periods) to determine when to activate a pump to move water from a storage container to an inertial flow control device.

Memory 430 may include a wide variety of memory media including, but not limited to, one or more of volatile memory, non-volatile memory, flash memory, programmable variables or states, random access memory (RAM), read-only memory (ROM), or other static or dynamic storage media.

In some examples, I/O interfaces 440 may provide an interface via a wired or wireless communication medium or link (e.g., communication link 155) between treatment control module 150 and elements of system 100 (e.g., pump 150). I/O interfaces 440 may include interfaces that operate according to various communication protocols to allow treatment control module 150 to communicate over these communication mediums or links (e.g., USB, IEEE 1394, IEEE, 802.1, IEEE 802.11, IEEE 802.16, GSM, GPRS, EDGE, W-CDMA, HSPA, LTE, CDMA-2000, EV-DO, etc.).

In some examples, treatment control module 150 includes one or more applications 450 to provide instructions to control logic 420 and/or treatment logic 410. Instructions, for example, may include instructions for treatment control module 150 to implement or use one or more of a timer feature 412 or a flow feature 414.

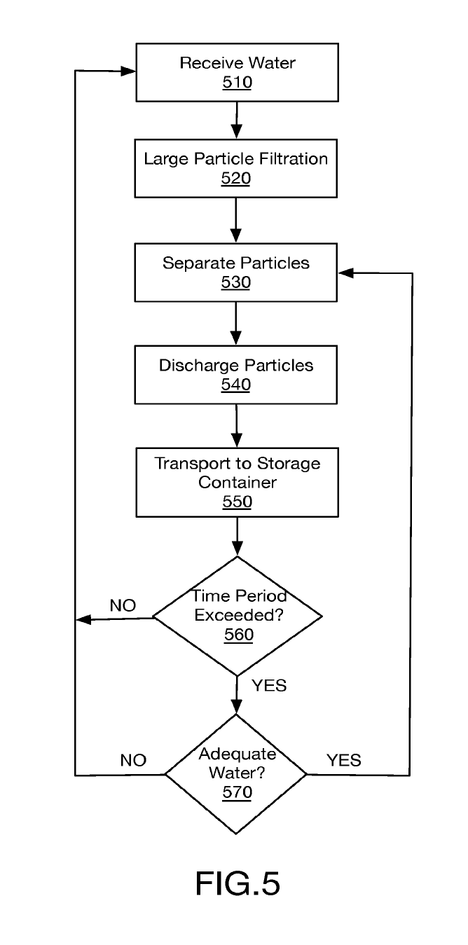

FIG. 5 illustrates a flow chart of example methods for treating water, arranged in accordance with at least some embodiments of the present disclosure. In some examples, elements of system 100 as shown in FIG. 1 or elements of inertial flow device 130 as shown in FIG. 2, are used to illustrate example methods related to the flow chart depicted in FIG. 5. Treatment control module 150 as shown in FIG. 4 may also be used to illustrate the example methods. But the described methods are not limited to implementations using elements of system 100, inertial flow device 130 or treatment control module 150. The example methods may be implemented using other elements of other systems, inertial flow devices or control modules having one or more of the elements depicted in FIG. 1, 2 or 4.

Beginning at block 510 (Receive Water), water may be received from water collection manifold 110 via receive stream 105. In some examples, the water may have been collected from one or more sources to include residential grey water sources.

Continuing from block 510 to block 520 (Large Particle Filtration), the received water may then be filtered by large particle filtration module 120. In some examples, large particle filtration may include the removal of particles in the water having a nominal diameter of greater than 1 mm and also the removal of at least some grease from the water.

Continuing from block 520 to block 530 (Separate Particles), the filtered water may then be transported to inertial flow device 130 via inlet stream 115. In some examples, particles associated with bacteria and/or organic matter may be separated from the water via an inertial flow device 130 having flow channel 200 configured to laterally focus the particles. As mentioned above, flow channel 200 may include mid-section 210 configured to either laterally focus the particles to the outer or inner portion of flow channel 200 in order to separate the particles from at least a portion of the water.

Continuing from block 530 to block 540 (Discharge Particles), the separated particles associated with bacteria and/or organic matter may be discharged from the flow channel via discharge stream 125. In some examples, discharge stream 125 may move the separated particles to a sewer system.

Continuing from block 540 to block 550 (Transport to Storage Container), the remaining water in flow channel 200 may be transported or moved to storage container 140 via outlet stream 135. In some examples, storage container 140 may be a container or storage tank to hold treated water to be used for applications such as providing irrigation for a residence's landscaping.

Continuing from block 550 to decision block 560 (Time Period Exceeded?), treatment control module 150 may include logic and/or features configured to determine whether a predetermined time period has been exceeded (e.g., via timer feature 412). In some examples, timer feature 412 may maintain a timer set for a predetermined period of time (e.g., 24 hours). If the timer has expired, the process proceeds to decision block 570. Otherwise, the process continues processing at block 510.

Proceeding from decision block 560 to decision block 570 (Adequate Water?), treatment control module 150 may include logic and/or features configured to determine whether an adequate amount of water is in storage container 140 (e.g., via flow feature 414). In some examples, a check for an adequate amount of water in storage container 140 may conserve energy and prevent the needless activation of pump 160 if there is relatively little are no water in storage container 140. If storage container 140 contains an adequate amount of water, the process continues processing at block 530 and the water may be retreated. Otherwise, the process continues processing at block 510 and more water may be received, treated and moved to storage container 140 as described above.

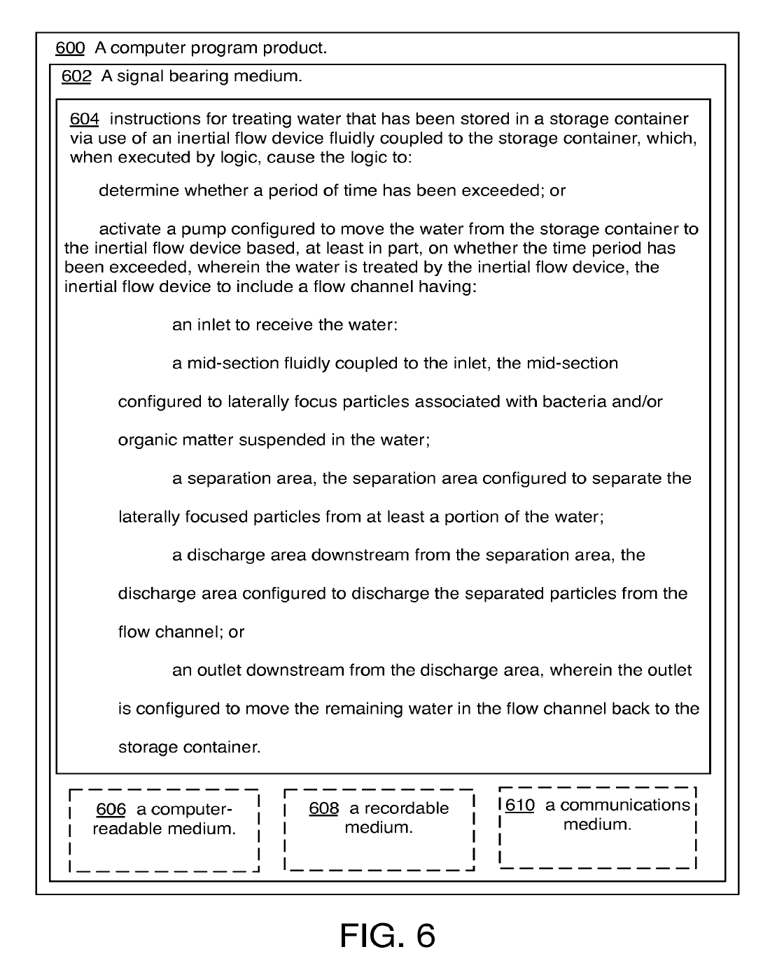

FIG. 6 illustrates a block diagram of an example computer program product 600, arranged in accordance with at least some embodiments of the present disclosure. In some examples, as shown in FIG. 6, computer program product 600 includes a signal bearing medium 602 that may also include instructions 604 for treating water that has been stored in a storage container (e.g., storage container 140) via use of an inertial flow device (e.g., inertial flow device 130) fluidly coupled to the storage container. Instructions 604, which, when executed by logic (e.g., treatment logic 410), may cause the logic to determine whether a period of time has been exceeded. The instructions 604 may also cause the logic to activate a pump (e.g., pump 160) configured to move the water from the storage container to the inertial flow device based, at least in part, on whether the time period has been exceeded.

In some examples, the water is treated by the inertial flow device. The inertial flow device may include a flow channel having an inlet to receive the water. The flow channel may also have a mid-section fluidly coupled to the inlet that may be configured to laterally focus particles associated with bacteria and/or organic matter suspended in the water. The flow channel may also have a separation area that may be configured to separate the laterally focused particles from at least a portion of the water. The flow channel may also have a discharge area downstream from the separation area that may be configured to discharge the separated particles from the flow channel. Further, the flow channel may have an outlet downstream from the discharge area that may be configured to move the remaining water in the flow channel back to the storage container.

Also depicted in FIG. 6, in some examples, computer product 600 may include one or more of a computer readable medium 606, a recordable medium 608 and a communications medium 610. The dotted boxes around these elements depict different types of mediums included within, but not limited to, signal bearing medium 602. These types of mediums may distribute instructions 604 to be executed by logic (e.g., treatment logic 410). Computer readable medium 606 and recordable medium 608 may include, but are not limited to, a flexible disk, a hard disk drive (HDD), a Compact Disc (CD), a Digital Versatile Disk (DVD), a digital tape, a computer memory, etc. Communications medium 610 may include, but is not limited to, a digital and/or an analog communication medium (e.g., a fiber optic cable, a waveguide, a wired communication link, a wireless communication link, etc.).

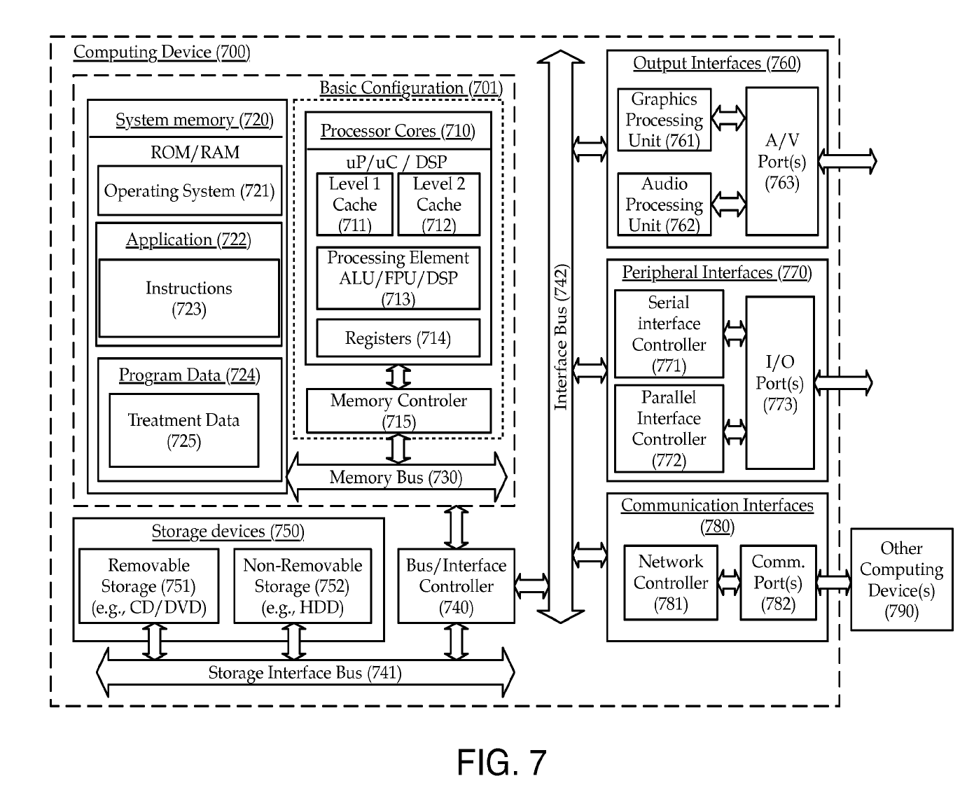

FIG. 7 illustrates an example computing device 700, arranged in accordance with at least some embodiments of the present disclosure. In some examples, treatment control module 150 depicted in FIG. 4 may be implemented on computing device 700. In these examples, elements of computing device 700 may be arranged or configured for treating water that has been stored in a storage container via use of an inertial flow device fluidly coupled to the storage container. In a very basic configuration 701, computing device 700 typically includes one or more processors 710 and system memory 720. A memory bus 730 can be used for communicating between the processor 710 and the system memory 720.

Depending on the desired configuration, processor 710 can be of any type including but not limited to a microprocessor (μP), a microcontroller (μC), a digital signal processor (DSP), or any combination thereof. Processor 710 can include one or more levels of caching, such as a level one cache 711 and a level two cache 712, a processor core 713, and registers 714. The processor core 713 can include an arithmetic logic unit (ALU), a floating point unit (FPU), a digital signal processing core (DSP Core), or any combination thereof. A memory controller 715 can also be used with the processor 710, or in some implementations the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes an operating system 721, one or more applications 722, and program data 724. Application 722 includes instructions 723 that are arranged to perform the functions as described herein including the actions described with respect to the treatment control module architecture shown in FIG. 4. Program Data 724 includes treatment data 725 that is useful for implementing instructions 723 (e.g., treating water). In some examples, application 722 can be arranged to operate with program data 724 on an operating system 721 such that implementations for treating water that has been stored in a storage container may be provided as described herein. This described basic configuration is illustrated in FIG. 7 by those components within dashed line 701.

Computing device 700 can have additional features or functionality, and additional interfaces to facilitate communications between the basic configuration 701 and any required devices and interfaces. For example, a bus/interface controller 740 can be used to facilitate communications between the basic configuration 701 and one or more data storage devices 750 via a storage interface bus 741. The data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 720, removable storage 751 and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include an interface bus 742 for facilitating communication from various interface devices (e.g., output interfaces, peripheral interfaces, and communication interfaces) to the basic configuration 701 via the bus/interface controller 740. Example output interfaces 760 include a graphics processing unit 761 and an audio processing unit 762, which can be configured to communicate to various external devices such as a display or speakers via one or more A/V ports 763. Example peripheral interfaces 760 include a serial interface controller 771 or a parallel interface controller 772, which can be configured to communicate with external devices such as input devices (e.g., keyboard, mouse, pen, voice input device, touch input device, etc.) or other peripheral devices (e.g., printer, scanner, etc.) via one or more I/O ports 773. An example communication interface 780 includes a network controller 781, which can be arranged to facilitate communications with one or more other computing devices 790 over a network communication via one or more communication ports 782. A network communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) electronic device such as a cell phone, smart phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations or implemented in a workstation or a server configuration.

References made in this disclosure to the term “responsive to” or “in response to” are not limited to responsiveness to a particular feature and/or structure. A feature may also be responsive to another feature and/or structure and also be located within that feature and/or structure. Moreover, when terms or phrases such as “coupled” or “responsive” or “in response to” or “in communication with”, etc. are used herein or in the claims that follow, these terms should be interpreted broadly. For example, the phrase “coupled to” may refer to being communicatively, electrically, fluidly and/or operatively coupled as appropriate for the context in which the phrase is used.

Those skilled in the art will recognize that it is common within the art to describe devices and/or processes in the fashion set forth herein, and thereafter use engineering practices to integrate such described devices (e.g., transmitters, receivers, wireless devices, computing platforms, computing devices, etc.) and/or methods into data processing systems. That is, at least a portion of the devices and/or methods described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available component, such as those typically found in data computing/communication and/or network computing/communication systems.

The herein described subject matter sometimes illustrates different components or elements contained within, or connected with, different other components or elements. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for treating water comprising:
receiving the water from one or more sources, the water having particles associated with bacteria and/or organic matter;
filtering the water through a large particle filtration module;
at a separation area downstream of the large particle filtration module, separating the particles from at least a portion of the water via a first inertial flow device, wherein the first inertial flow device includes a flow channel configured to laterally focus the particles;
discharging the separated particles from the flow channel; and
transporting remaining water in the flow channel to a storage container;
storing the remaining water in the flow channel in the storage container; and
treating the stored water periodically via a second inertial flow device fluidly coupled to the storage container, wherein treating includes separating additional particles associated with bacteria and/or organic matter suspended in the stored water.

2. The method according to claim 1, wherein the one or more sources comprises a residential source including one or more of shower wastewater, bath wastewater, bathroom sink wastewater, kitchen sink wastewater, or laundry wastewater.

3-4. (canceled)

5. The method according to claim 1, wherein the flow channel configured to laterally focus the particles comprises at least one of a square-shaped or a circular-shaped flow channel, the particles to be laterally focused to an outer portion of the flow channel, the laterally focused particles to be separated from at least the portion of the water at the downstream separation point, wherein the laterally focused particles are to be separated at the outer portion of the flow channel.

6. The method according to claim 1, wherein the flow channel configured to laterally focus the particles comprises an asymmetric curve-shaped flow channel, the particles to be laterally focused to an inner portion of the flow channel, the laterally focused particles to be separated from at least the portion of the water at the downstream separation point, wherein the laterally focused particles are to be separated at the inner portion of the flow channel.

7. The method according to claim 1, wherein the large particle filtration module filters particles having a nominal diameter greater than about 1 millimeter.

8. An apparatus for treating water comprising:
a first inertial flow device having a first flow channel including:
a first inlet configured to receive water that has been filtered through a large particle filtration module;
a first mid-section fluidly coupled to the first inlet, the first mid-section configured to laterally focus particles associated with bacteria and/or organic matter suspended in the water;
a first separation area along the flow channel, the first separation area configured to separate the laterally focused particles from at least a portion of the water;
a first discharge area downstream from the first separation area, the first discharge area configured to discharge the separated particles from the first flow channel; and
a first outlet downstream from the first discharge area, wherein the first outlet is configured to transport the remaining water in the first flow channel to a storage container; and
a second inertial flow device to periodically treat water stored in the storage container, the second inertial flow device having a second flow channel including;
a second inlet configured to receive water from the storage container;
a second mid-section fluidly coupled to the second inlet, the second mid-section configured to laterally focus particles associated with bacteria and/or organic matter suspended in the water;
a second separation area along the flow channel, the second separation area configured to separate the laterally focused particles from at least a portion of the water;
a second discharge area downstream from the second separation area, the second discharge area configured to discharge the separated particles from the second flow channel; and
a second outlet downstream from the second discharge area, wherein the second outlet is configured to transport the remaining water in the first flow channel to the storage container.

9. The apparatus according to claim 8, wherein the one or more sources comprises a residential source to include one or more of shower wastewater, bath wastewater, bathroom sink wastewater, kitchen sink wastewater, or laundry wastewater.

10. The apparatus according to claim 8, further comprising:
a treatment conduit fluidly coupled to the storage container and fluidly coupled to the second inlet of the second flow channel;
a pump configured to move stored water from the storage container via the treatment conduit to the second inlet of the second flow channel; and
a treatment control module, the treatment control module having logic configured to periodically activate the pump to move the stored water from the storage container via the treatment conduit to the second inlet of the second flow channel, wherein the stored water is treated via the second inertial flow device to separate additional particles associated with bacteria and/or organic matter suspended in the stored water.

11. The apparatus according to claim 8, wherein the first mid-section and the second mid-section separately comprise[s] one of a square-shaped or a circular-shaped mid-section, the particles to be laterally focused to an outer portion of the first or second flow channel, the laterally focused particles to be separated from at least the portion of the water at the first or second separation point of the first or second flow channel, wherein the laterally focused particles are to be separated at the first or second outer portion of the first or second flow channel.

12. The apparatus according to claim 8, wherein the first mid-section and the second mid-section separately comprise[s] an asymmetric curve-shaped flow channel, the particles to be laterally focused to an inner portion of the first or second flow channel, the laterally focused particles to be separated from at least the portion of the water at the downstream first or second separation point, wherein the laterally focused particles are to be separated at the inner portion of the first or second flow channel.

13. The apparatus according to claim 8, wherein the water that has been filtered through a large particle filtration module comprises water having been filtered through a large particle filtration module that filters particles having a nominal diameter greater than about 1 millimeter.

14. A system comprising:
a large particle filtration module configured to filter water received from one or more sources;
a storage container;
an inertial flow device to include a flow channel, the flow channel comprising:
an inlet configured to receive water that has been filtered through the large particle filtration module;
a mid-section, fluidly coupled to the inlet, the mid-section configured to laterally focus particles associated with bacteria and/or organic matter suspended in the water;
a separation area, the separation area configured to separate the laterally focused particles from at least a portion of the water;
a discharge area downstream from the separation area, the discharge area configured to discharge the separated particles from the flow channel; and
an outlet downstream from the discharge area, wherein the outlet is configured to move the remaining water in the flow channel to the storage container, container; and
a treatment inertial flow device fluidly coupled to the storage container, the treatment inertial flow device configured to periodically treat water stored in the storage container, treatment to include separating other particles associated with bacteria and/or organic matter from the stored water.

15. The system according to claim 14, wherein the water received from one or more sources comprises water received from a residential source to include one or more of shower wastewater, bath wastewater, bathroom sink wastewater, kitchen sink wastewater, or laundry wastewater.

16. The system according to claim 14 further comprising:
a treatment conduit, fluidly coupled between the storage container and the treatment inertial flow device;
a pump configured to move stored water from the storage container via the retreatment conduit to an inlet of the treatment inertial flow device; and
a control module, the control module having logic configured to periodically activate the pump to transport the stored water from the storage container via the treatment conduit to the inlet of the treatment inertial flow device, wherein the stored water is treated via use of the treatment inertial flow device to separate additional particles associated with bacteria and/or organic matter suspended in the stored water.

17. (canceled)

18. The system according to claim 14, wherein the treatment inertial flow device further comprises:
a treatment flow channel that includes:
a treatment inlet configured to receive the stored grey water from the storage container;
a treatment mid-section fluidly coupled to the treatment inlet, the treatment mid-section configured to laterally focus additional particles associated with bacteria and/or organic matter suspended in the stored water;
a treatment separation area to separate the laterally focused additional particles from at least a portion of the stored water;
a treatment discharge area downstream from the treatment separation area to discharge the separated additional particles from the treatment flow channel; and
a treatment outlet downstream from the treatment discharge area, wherein treatment outlet is configured to move the stored water remaining in the treatment flow channel back to the storage container.

19. The system according to claim 14, wherein the mid-section of the flow channel comprises at least one of a square-shaped or a circular-shaped mid-section, the particles to be laterally focused to an outer portion of the flow channel, the laterally focused particles to be separated from at least the portion of the filtered grey water at the separation point of the flow channel, wherein the laterally focused particles are to be separated at the outer portion of the flow channel.

20. The system according to claim 14, wherein the mid-section of the flow channel comprises an asymmetric curve-shaped flow channel, the particles to be laterally focused to an inner portion of the flow channel, the laterally focused particles to be separated from at least the portion of the filtered water at the downstream separation point, wherein the laterally focused particles are to be separated at the inner portion of the flow channel.

21. The system according to claim 14, wherein the large particle filtration module comprises the large particle filtration module configured to filter particles having a nominal diameter greater than about 1 millimeter from the water.

22. A computer program product comprising a signal-bearing medium having instructions for treating water that has been stored in a storage container via use of an inertial flow device fluidly coupled to the storage container, which, when executed by logic, cause the logic to:
determine whether a period of time has been exceeded; and
activate a pump configured to move the water from the storage container to the inertial flow device based, at least in part, on whether the time period has been exceeded, wherein the water is treated by the inertial flow device, the inertial flow device to include a flow channel having:
an inlet to receive the water;
a mid-section fluidly coupled to the inlet, the mid-section configured to laterally focus particles associated with bacteria and/or organic matter suspended in the water;
a separation area, the separation area configured to separate the laterally focused particles from at least a portion of the water;
a discharge area downstream from the separation area, the discharge area configured to discharge the separated particles from the flow channel; and
an outlet downstream from the discharge area, wherein the outlet is configured to move the remaining water in the flow channel back to the storage container;
store the remaining water in the flow channel in the storage container; and
treat the stored water periodically via a second inertial flow device fluidly coupled to the storage container, wherein to treat the stored water includes separating additional particles associated with bacteria and/or organic matter suspended in the stored water.

23. The computer program product according to claim 22, wherein the water originated from a residential source to include one or more of shower wastewater, bath wastewater, bathroom sink wastewater, kitchen sink wastewater or laundry wastewater.

24. The computer program product according to claim 22, wherein the period of time comprises approximately 24 hours.

25. The computer program product according to claim 22, wherein the flow channel mid-section comprises at least one of a square-shaped or a circular-shaped mid-section, the particles to be laterally focused to an outer portion of the flow channel, the laterally focused particles to be separated from at least the portion of the water at the separation point of the flow channel, wherein the laterally focused particles are to be separated at the outer portion of the flow channel.

26. The computer program according to claim 22, wherein the flow channel mid-section comprises an asymmetric curve-shaped flow channel, the particles to be laterally focused to an inner portion of the flow channel, the laterally focused particles to be separated from at least the portion of the water at the downstream separation point, wherein the laterally focused particles are to be separated at the inner portion of the flow channel.
